(19) United States
(12) Patent Application Publication
(10) Pub. No.: US 2006/0017287 A1
(43) Pub. Date: Jan. 26, 2006

(54) Tie-back connection for subsea well

(75) Inventor: Lionel J. Milberger, Wheelock, TX (US)

Correspondence Address: LOREN G. HELMREICH, 5718 WESTHEIMER, SUITE 1800, HOUSTON, TX, 77057, US

(73) Assignee: Dril-Quip, Inc., Houston, TX (US)

(21) Appl. No.: 10/526,947

(22) PCT Filed: Sep. 9, 2003
(86) PCT No.: PCT/US03/28324

§ 371 Date: Mar. 8, 2005

Related U.S. Application Data
(60) Provisional application No. 60/409,092, filed on Sep. 9, 2002.

(51) Int. Cl. F16L 23/00

(52) U.S. Cl. 285/412

(57) ABSTRACT

A connection structure is disclosed for connecting a riser to a subsea wellhead assembly. The connection structure allows components of the tie-back connector (16) to be assembled over the tie-back connector before the tie-back connector is secured to a long stress joint, to avoid the need to maneuver the components over the long stress joint. High strength materials are used in the construction of the stress joint to minimize the effects of stresses in the wellhead connector. The connection fixture provides electrical insulation (34) between the engagement points of the stress joint and the tie-back connector to minimize corrosive galvanic action. The connection structure provides an upwardly facing flange (18) that may be threaded or otherwise connected to the top of the tie-back connector and is adapted to mate with and secure to a downwardly facing flange (12a) carried at the bottom of the stress joint (12).

### CROSS-REFERENCE TO RELATED APPLICATIONS

This application is related to and claims benefit of U.S. Provisional Application Ser. No. 60/409092 filed Sep. 9, 2002 and assigned to the Assignee of the present application.

### FIELD OF THE INVENTION

The present invention relates to connectors for securing riser pipes to subsurface wellheads. More specifically, the present invention relates to an improved connection between a riser stress joint and a tie back connector.

### BACKGROUND OF THE INVENTION

An external string of pipe is frequently used to communicate fluids and well products between a subsea wellhead and a drilling or production structure located at the water surface. This string of pipe, frequently referred to as a riser, is subjected to strong lateral and longitudinal stresses caused by water currents and motion between the surface structure and the wellhead. Because the wellhead is stationary relative to the riser, these stresses concentrate in the connection between the riser and the wellhead.

Substantial effort has been exerted in the design of the structure used to connect the lower end of the riser string to the wellhead to minimize the effects of the stresses acting through the riser. A stress compensating tie-back connector may be used to tie back a subsea well to a floating surface structure such as a SPAR or tension leg platform. In these installations, the lower end of the riser connects to the top of a stress joint that is designed to connect to the wellhead to absorb part of the stresses exerted by the riser. The riser, stress joint and tie back connector are all run as a unit that is lowered through the water from the surface structure and secured to the subsea wellhead. Conventional prior art assemblies frequently construct the upper tie back connector body and the stress joint as a single piece component.

Where the upper tie back connector body and the stress joint are configured as a single piece component, difficulties can be encountered in the assembly of hydraulic actuation components or other mechanisms forming part of the tie back connector. This problem may be encountered, for example, where hydraulic lock actuation mechanisms used for securing the riser to the wellhead must be assembled over the top of the tie-back connector. Moreover, optimum stress reaction characteristics of the stress joint may not be attainable when the upper tie back connector body and the stress joint are constructed as a single piece component.

Constructing the upper tie back connector body and the stress joint of different materials, which could improve the stress capacity of the connection, introduces the problem of increased corrosion caused by the galvanic action resulting from the joinder of dissimilar materials in a saltwater environment.

### SUMMARY OF THE INVENTION

A connection structure is provided between a stress joint in a riser and a tie-back connector of a subsea wellhead. The connection structure joins a stress joint of one material with a wellhead tie-back connector of a different material. The connection structure allows components of the tie-back connector to be assembled over the tie-back connector without first having to be maneuvered over a long stress joint.

High stress capacity materials are used in the construction of the stress joint to minimize the effects of riser generated stresses in the wellhead connector. The connection fixture provides electrical insulation between the engagement points of the stress joint and the tie-back connector to minimize corrosive galvanic action.

In the preferred embodiment, the connection structure provides an upwardly facing flange extending from the top of the tie-back connector adapted to mate with and secure to a downwardly facing flange at the bottom of the stress joint. The upwardly facing flange is preferably threaded to the top of the tie-back connector.

In a modified form of the Invention, mechanically actuated radial dogs or C-ring locking members are used to secure the upwardly facing flange to the top of the tie-back connector.

From the foregoing, it will be appreciated that a primary object of the present invention is to provide a connection structure to join a stress joint to a tie-back connector of a subsea wellhead.

Another object of the present invention is to provide a connection structure to join a stress joint of one material to a tie-back connector of a different material.

Yet another object of the present invention is to provide a connection structure that permits components of a tie-back connector to be assembled without the obstruction provided by a stress joint integrally connected to the tie-back connector.

It is also an object of the present invention to minimize corrosion in an assembly of dissimilar metals in a connection between a subsea well and a stress joint.

The foregoing features, advantages and objects of the present invention will be more fully understood and better appreciated by reference to the following address vacation and claims.

### BRIEF DESCRIPTION OF THE DRAWINGS

FIG. 1 is a vertical sectional view of a connection structure of the present invention secured to the upper body (indicated in dotted line) of a tie-back connector.

FIG. 2 is an enlarged vertical sectional view of the connection structure of FIG. 1.

FIG. 3 is a vertical sectional view of a modified form of the connection structure of the present invention.

FIG. 4 is a vertical sectional view of yet another modified form of the connection structure of the present invention.

### DETAILED DESCRIPTION OF INVENTION

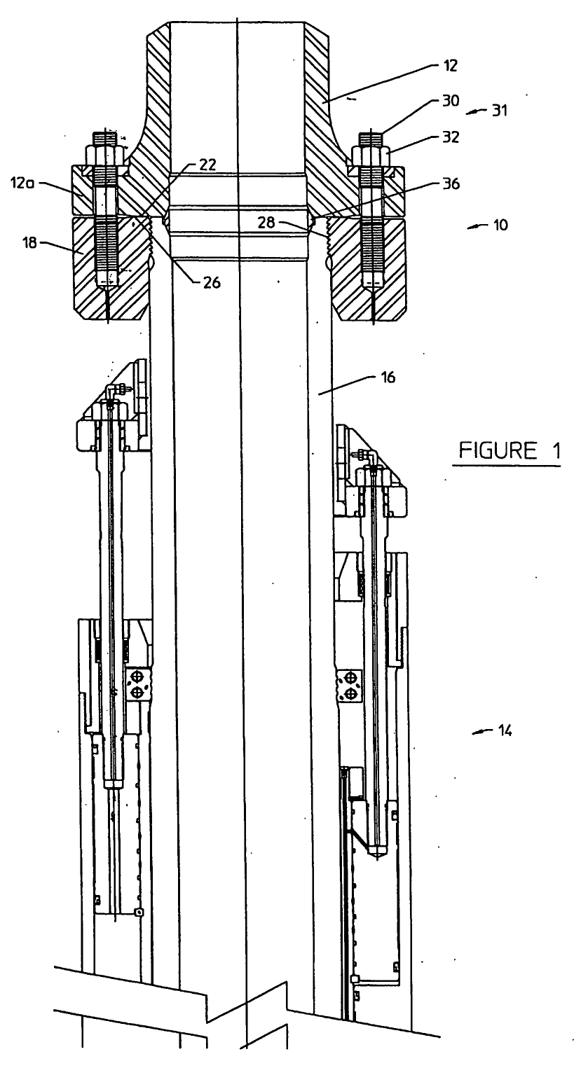

FIG. 1 illustrates a preferred embodiment of the connection structure of the present invention, indicated generally at 10, for connecting a stress joint 12 to a subsea wellhead assembly (not illustrated). An upper body of a tie-back connector, indicated generally at 14, extends toward the water surface from the subsea wellhead assembly. An example of the tie-back connector 14 is disclosed in U.S. patent application Ser. No. 09/954,998, now published in Pub. No. U.S. 2002/0096878, incorporated herein by reference for all purposes.

The tie-back connector 14 includes an elongate tubular tie-back body 16 and a tie-back flange 18 mechanically secured to the tie-back body 16. The tie-back flange 18 has a mating face 22 facing upwardly from the tie-back connector 14 for connecting to a flange 12a at the base of the stress joint 12.

The mechanical connection securing the connection structure 10 and the tie-back body 16 may comprise a threaded connection 28 between the tie-back flange 18 and the tie-back body. The threaded connection 28 may be a square thread or a buttress thread, and is preferably comprised of substantially the same material as the tie-back body 16. The stress joint flange 12a has a mating face 26 facing downwardly from the stress joint 12 for mating with the mating face 22 of the tie-back flange 18. Threaded fasteners 31, such as threaded studs 30 and nuts 32, may secure the stress joint flange 12a to the tie-back flange 18. The studs are threadably received within tapped bores formed in the tie-back flange 18. A gasket 36 provides a seal between the stress joint flange 12a and the tie-back flange 18.

The stress joint 12 including stress joint flange 12a is preferably constructed of a material, such as a titanium alloy, that exhibits high resistance to structural failure caused by fatigue damage. The top of the stress joint portion shown in the figures may be welded to an extended portion of stress joint. The tie-back body 16, including the flange 18, may be constructed of a much less expensive low alloy steel. The physical connection of the steel and titanium alloys in the presence of saltwater can produce damaging electrical currents that are conducive to rapid corrosion and destruction of the connection. The effects of this phenomenon are minimized by providing electrical insulators to separate the engagement points of the two metals. To this end, an electrically non-conductive bent insulating ring 34 is disposed between the tie-back body 16 and the stress joint flange 12a. The insulation ring 34 may comprise an upper sealing surface for sealing with the gasket 36 and for insulating between the gasket 36 and the riser flange 12a. The insulation ring may further serve as a spacer to space apart portions of mating faces 22 and 26 to prevent electrical contact between them (as shown, outer portions of mating faces 22 and 26 are angled to create a gap between them. In other embodiments, the insulation ring 34 may extend further between mating faces 22 and 26, to insulate greater area. Additionally, insulation washers 38 are positioned around the threaded studs 30, between the nuts 32 and the stress joint flange 12a, to complete the electrical isolation between the titanium stress joint 12 and the low alloy steel tie-back body 16. The insulators 34 and 38 may be constructed from any suitable material providing the desired isolation to electrical current flow between the dissimilar metals while simultaneously providing the necessary structural strength to withstand the compression imposed during the bolting together of the flanged components. Examples of such insulation material include ceramic or ceramic-coated steel. Additionally, an OD of the threaded studs 30 is preferably smaller than the mating hole in the flange 12a through which they pass, to create a gap around threaded studs 30 and prevent electrical contact between threaded studs 30 and flange 12a.

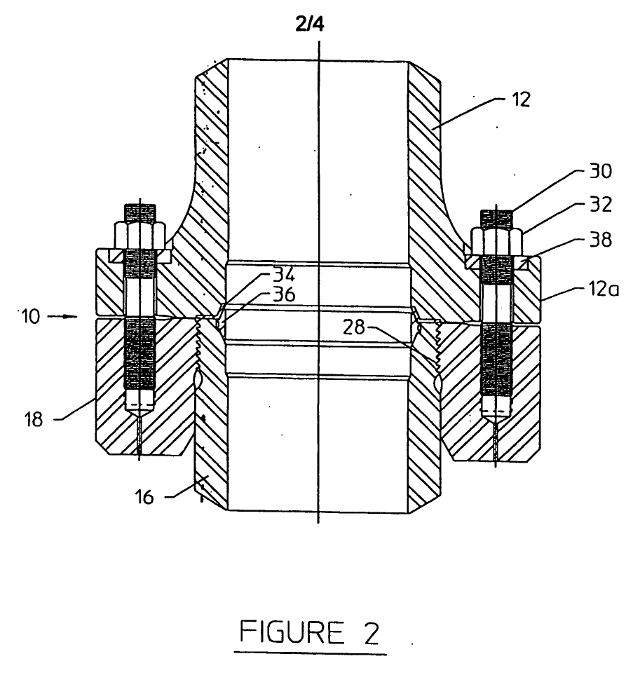

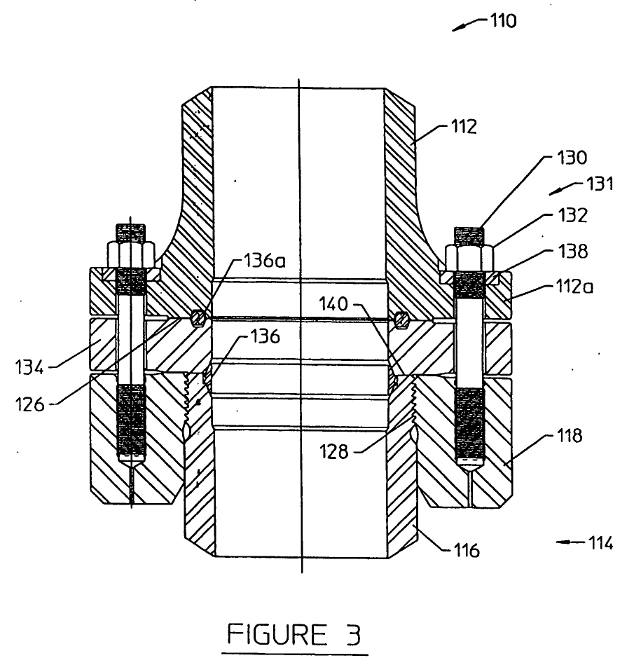

FIG. 3 illustrates a modified embodiment of the present invention indicated generally at 110. As with the embodiment of FIGS. 1 and 2, the connection structure 110 includes a tie-back connector indicated generally at 114 having an elongate tubular tie-back body 116 and a tie-back flange 118 mechanically connected to the tie-back body. Components of the embodiment of FIG. 3 that correspond with those of the embodiment of FIGS. 1 and 2, and function in the same or similar manner, have been accorded reference characters that are greater by 100 than the corresponding reference characters used in FIGS. 1 and 2. The tie-back body 116 terminates in a threaded male connection 128 that is threadably engaged with the tie-back flange 118 to form an upwardly facing flange face at the upper body of the tie-back connector 116. A riser flange 112a is formed at the base of a riser joint 112.

The stress joint flange 112 has a mating face 126 facing downwardly from the riser 112 to a sandwich flange 134 held between the stress joint flange 112a and the tie-back flange 118. Threaded fasteners 131 including studs 130 extend through flange openings in the flange 112a and sandwich flange 134 into threaded receptacles in the tie-back flange 118. Nuts 132 are tightened onto the studs 130 to secure the components together. Compression seals 136 and 136a prevent leakage in the connection structure 110.

The sandwich flange 134 is constructed of an electrical insulating material such as described above to prevent the generation of galvanic currents between the stress joint 112 and the tie-back body 116. The insulating washers 138 prevent current flow through the studs 130.

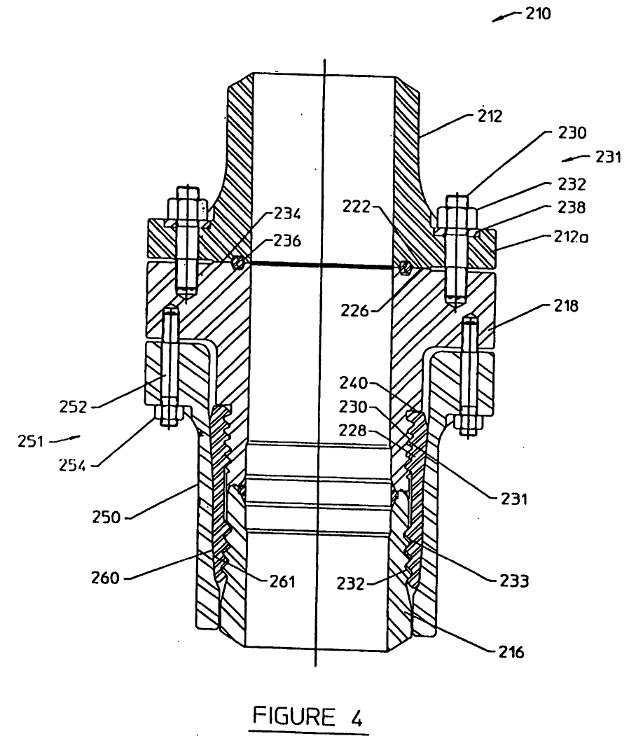

FIG. 4 illustrates another embodiment of the connection structure of the present invention indicated generally at 210. As with the embodiment of FIGS. 1-3, the connection structure 210 includes an elongate tubular tie-back body 216 and a tie-back flange 218 mechanically connected to the tie-back body 216. Components of the embodiment of FIG. 4 that correspond with those of the embodiment of FIGS. 1-3, and function in the same or similar manner, have been accorded reference characters that are greater by 100 than the corresponding reference characters used in FIG. 3. In contrast to the threaded connections 28 and 128 used to connect the tie-back bodies 16, 116 with the tie-back flanges 18, 118, respectively, in FIGS. 1, 2, and 3, the connection structure 210 employs a radially movable latch member 228 for connecting the tie-back body 216 and the tie-back flange 218. The latch member 228 is constructed with upper and lower sets of circumferentially extending teeth 230 and 232, adapted to respectively engage grooves 231 and 233 about adjacent ends of the tie-back body 216 and the tie-back flange 218 when the latch member 228 is moved radially inward. The latch member 228 may comprise a plurality of mechanically actuated dogs or a one-piece C-ring locking member.

The latch member 228 may be retained in the radially inward position illustrated in FIG. 4 by a tubular retaining member 250. The retaining member is secured with retaining member 251 including threaded studs 252 and nuts 254. The threaded studs 252 are received in tapped receptacles formed in the flange connector 218.

Radial movement of the latch member 228 into the radially inward position may be caused by axial movement of the retaining member 250 relative to the latch member 228, such as occurs when the bolts 254 are tightened on the studs 252. Mating cam surfaces 260, 261 on the latch member 228 and the retaining member 250 slidably engage during the axial movement of the retaining member 250 to cause the radial movement of the latch member 228.

The tie-back flange 218 has an upwardly facing mating face 222 for connecting to a stress joint 212. A stress joint flange 212a at the base the of the joint 212 has a mating face 226 facing downwardly for mating with the mating face 222 of the tie-back flange 218. Studs 230 and nuts 232 secure the joint 212 to the tie-back flange 218. An insulation ring 234 between the opposing faces and 222 and 226 provides electrical insulation between the engagement points of the stress joint 212 and the tie-back flange 218. Insulating washers 238 complete the electrical insulation of the dissimilar metals of the connection structure from each other.

Although specific embodiments of the invention have been described herein in some detail, it is to be understood that this has been done solely for the purposes of describing the various aspects of the invention, and is not intended to limit the scope of the invention as defined in the claims which follow. Those skilled in the art will understand that the embodiments shown and described are exemplary and various other substitutions, alternations, and modifications, including but not limited to those design alternative specifically discussed herein, may be made in the practice of the invention without departing from the spirit and scope of the invention.

1. An apparatus for connecting a riser to a subsea wellhead assembly, comprising:
a tie-back connector for connection to the wellhead assembly, the connector including an elongate tubular tie-back body and a connector assembly radially outward of the tubular tie-back body; and
a tie-back flange assembly having first and second flanges, with said first body flange having a connection for separable connection to an axial end of the tie-back body and said second riser flange for connecting to the riser, said tie-back body and said riser each formed from a metallic material, said riser and said riser flange being removable from said body flange, and said body flange being removable from said tie-back body for insertion or removal of said connector assembly on said tie-back body.

2. An apparatus as defined in claim 1, further comprising:
the riser flange mechanically connected to the riser, the riser flange having a mating face for engagement with the tie-back body flange; and
a securing structure for removably securing the riser flange to the tie-back body flange at their mating faces.

3. An apparatus as defined in claim 2, wherein the tie-back body and the riser flange are of dissimilar materials.

4. An apparatus as defined in claim 3, further comprising:
an insulator for electrically insulating between the tie-back body and the riser flange.

5. An apparatus as defined in claim 4, wherein the insulator comprises:
an insulation ring between the tie-back body and the riser flange.

6. An apparatus as defined in claim 4, wherein the insulator comprises:
one or more insulation washers positioned between a corresponding one or more threaded members joining the riser flange with the tie-back body flange.

7. An apparatus as defined in claim 1, further comprising:
a threaded connection between the tie-back body flange and the tie-back body.

8. (canceled)

9. An apparatus as defined in claim 81, further comprising:
a sandwich flange for positioning between the mating faces of the tie-back body flange and the riser flange.

10. An apparatus as defined in claim 9, wherein the sandwich flange comprises:
an insulating material for electrically insulating between the riser flange and the tie-back body flange.

11. An apparatus as defined in claim 1, further comprising:
a radially movable latch member for connecting the tubular tie-back body and the tie-back body flange, the latch member comprising upper and lower teeth adapted to engage grooves about adjacent ends of the tubular tie-back body and the tie-back body flange when the latch member is moved radially inwardly.

12. An apparatus as defined in claim 11, wherein the radially movable latch member comprises:
mechanically actuated dogs or a C-ring locking member.

13. (canceled)

14. (canceled)

15. An apparatus as defined in claim 1, further comprising:
a seal member for sealing between the riser flange and the tubular tie-back body.

16. An apparatus as defined in claim 1, wherein the tie-back body is a low alloy steel and the riser flange is a titanium alloy.

17. An Apparatus for connecting a riser to a subsea wellhead assembly, comprising:
a tie-back connector for connection to the wellhead assembly, the tie-back connector including an elongate tubular tie-back body and a connector assembly radially outward of the tubular body;
a tie-back body flange mechanically connected to the tie-back body, the tie-back body flange having a mating face facing upwardly from the tie-back connector for connecting to the riser, the tie-back body flange comprising different materials than materials comprising the riser;
a riser flange connected to one axial end of the riser, the riser flange having a mating face facing away from the riser, for mating with the mating face of the tie-back body flange, said tie-back body and said riser each formed from a metallic material, said riser and said riser flange being removable from said body flange, and said body flange being removable from said tubular body for insertion or removal of said connector assembly on said tubular body;
a threaded connection between the tie-back body flange and the tie-back body; and
an electrical insulation material separating the different materials of the tie-back connector and the riser flange.

18. Apparatus for connecting a riser to a subsea wellhead assembly, comprising:
a tie-back connector for connection to the wellhead assembly, the tie-back connector including an elongate tubular tie-back body and a connector assembly radially outward of the tubular body;
a tie-back flange assembly having first and second flanges, with said first body flange having a connection for separable connection to an axial end of the tie-back body and said second riser flange having a mating face for connecting to a riser;
said tie-back body and said riser each formed from a metallic material;
a riser flange mechanically connected to the riser, the riser flange having a mating face facing downwardly from the riser, said riser and said riser flange being removable from said body flange, and said body flange being removable from said tie-back body for insertion or removal of said connector assembly on said tie-back body;
a threaded connection between the tie-back body flange and the tie-back body;
a sandwich flange for positioning between the mating faces of the tie-back body flange and the riser flange, the sandwich flange comprising an insulating material for electrically insulating between the riser flange and one or more of the tubular tie-back body and the tie-back body flange;
one or more threaded members passing through and joining the sandwich flange, the riser flange, and the tie-back body flange; and
one or more insulation washers positioned between a corresponding one or more threaded members joining the riser flange with the tie-back body flange.

19. Apparatus for connecting a riser to a subsea wellhead assembly, comprising:
a tie-back connector for connection to the wellhead assembly, the tie-back connector including an elongate tubular tie-back body and a connector assembly radially outward of the tubular body;
a tie-back body flange mechanically connected to the tie-back body, the tie-back flange having a mating face facing upwardly from the tie-back connector for connecting to the riser, said tie-back body and said riser each formed from a metallic material;
a riser flange mechanically connected to the riser, the riser flange having a mating face facing downwardly from the riser for mating with the mating face of the tie-back flange, said riser and said riser flange being removable from said body flange, and said body flange being removable from said tie-back body for insertion or removal of said connector assembly on said tie-back body;
a radially movable latch member for connecting the tubular tie-back body and the tie-back body flange, the latch member comprising upper and lower teeth adapted to engage grooves about adjacent ends of the tubular tie-back body and the tie-back body flange when the latch member is moved radially inwardly;
one or more threaded members passing through and joining the riser flange and the tie-back body flange; and
an insulator including an insulation ring between the tubular tie-back body and the tie-back body flange and one or more insulation washers positioned between a corresponding one or more threaded members joining the riser flange with the tie-back body flange.

20. A connection structure for securing a riser to a subsurface wellhead assembly, comprising:
an elongate, tubular connection body having first and second axial ends;
a tie-back connector for connection to the wellhead assembly, the connector including an elongate tubular tie-back body and a connector assembly radially outward of the tubular body;
a wellhead engagement structure at the first axial of the body and riser connection structure at the second axial end of the tubular body;
a tie-back body flange mechanically connected to the tie-back body, the tie-back body flange having a mating face facing upwardly from the connector assembly for connecting to the riser, said tie-back body and said riser each formed from a metallic material, said riser being removable from a tie-back body flange at an upper end of said tie-back body, and said body flange being removable from said tie-back body for insertion or removal of said connector assembly on said tie-back body; and
an electrical insulating material carried at the second axial end of the tubular connection body for electrically insulating the tubular connection body from the riser.

21. A connection structure as defined in claim 20 wherein said riser comprises a flange at an axial end of the riser.

22. A connection structure as defined in claim 21 wherein said electrical insulating material is carried on the body flange.

23. A connection structure as defined in claim 21 wherein said body flange is threadably engaged to said tubular connection body.

24. A connection structure as defined in claim 21 wherein said body flange is connected to said tubular connection body by a radially movable clamping element.
